(19) United States
(12) Patent Application Publication
(10) Pub. No.: US 2011/0228289 A1
(43) Pub. Date: Sep. 22, 2011

(54) INKJET PRINTER

(75) Inventors: Akihito Yamamoto, Wakayama-shi (JP); Yoshihisa Higashimoto, Wakayama-shi (JP); Nobuaki Nakaoka, Wakayama-shi (JP); Hideya Miyazaki, Wakayama-shi (JP)

(73) Assignee: NORITSU KOKI CO., LTD., Wakayama-shi, Wakayama (JP)

(21) Appl. No.: 12/671,668

(22) PCT Filed: Jul. 14, 2008
(86) PCT No.: PCT/JP2008/001887

§ 371 Date: Feb. 1, 2010

(30) Foreign Application Priority Data
Aug. 2, 2007 (JP) 2007-202164
Aug. 2, 2007 (JP) 2007-202185
Aug. 21, 2007 (JP) 2007-215028

(51) Int. Cl. G06K 15/10

(52) U.S. Cl. 358/1.8

(57) ABSTRACT

An inkjet printer A includes: a casing 6 having an output port 47 through which printing paper P1, P2 after printing is output to outside the casing 6; a drying chamber 71 provided downstream, in a paper conveyance direction, of a print head H on a conveyance path in the casing 6, and communicating with the output port 47; and a dryer 72 configured to blow, into the drying chamber 71, dry wind W for drying ink on the printing paper P1, P2 after printing. The dryer 72 is configured to blow the dry wind W downstream in the paper conveyance direction in the drying chamber 72. Dry wind W from the dryer 72 is blown to outside the casing 6 through the output port 47.

### TECHNICAL FIELD

The present disclosure relates to inkjet printers for printing an image on paper by ejecting ink from a print head onto the paper during conveyance of the paper.

### BACKGROUND ART

An inkjet printer generally includes a printing part with a print head for performing printing by ejecting ink onto paper. This print head ejects ink onto paper conveyed to the printing part by a conveyance mechanism, while reciprocating along a direction (i.e., a main scanning direction) perpendicular to a direction (i.e., a sub-scanning direction) in which the paper is conveyed, thereby printing an image (including characters and the like; the same hereinafter) on the paper. The printed paper is output on a paper output tray.

Here, in a printer operating at a low printing speed, ink on printed paper dries before the printed paper is output on a paper output tray. Thus, this ink does not need to be dried by heat. On the other hand, in a high-performance printer operating at a high printing speed, printed paper is output on a paper output tray before ink is air-dried. To prevent this, in this high-performance printer, ink on the printed paper needs to be dried by heat. Specifically, when paper is output on previous paper on which ink has not dried yet, ink on the lower paper is touched by the upper paper, thereby degrading print quality of the lower paper, and causes ink to be attached to the back surface of the upper paper to make this surface dirty. In addition, outputting the additional paper causes nonuniformity in drying the ink on the lower paper, also resulting in degradation of print quality. To solve these problems, in the high-speed printer, ink on printed paper needs to be dried by heat.

For example, in Patent Document 1, a drying unit including a heating roller, an infrared heater, and an air nozzle is provided to dry ink on printed paper. The surface of the paper is heated with the heating roller and the infrared heater, thereby drying ink by heat. Then, air is brown from the air nozzle to this heated paper surface, thereby reducing the temperature of the paper surface.

### CITATION LIST

### Patent Document

PATENT DOCUMENT 1: Japanese Patent Publication No. 2001-270089

### SUMMARY OF THE INVENTION

### Technical Problem

In the above conventional inkjet printer, ink dries only on a portion of paper facing the infrared heater during conveyance of the paper. Thus, to sufficiently dry ink on the paper, the paper needs to face the infrared heater for a long time. Accordingly, it is difficult to increase the conveyance speed of the paper, and thus, performance of the printer cannot be enhanced.

It is therefore an object of the present invention to provide an inkjet printer which can ensure a paper drying period as long as possible, without reducing the conveyance speed of paper.

### Solution to the Problem

To achieve the object, according to the present disclosure, a dryer is configured to blow dry wind downstream in the paper conveyance direction in a drying chamber. The dry wind from the dryer is released to outside a casing through an output port of the casing.

Specifically, a first aspect of the present invention is directed to an inkjet printer configured to print an image on paper by ejecting ink from a print head onto the paper while conveying the paper. The inkjet printer includes: a casing incorporating the print head and having an output port through which the printed paper is output to outside the casing; a drying chamber provided on a conveyance path downstream of the print head in a paper conveyance direction in the casing, and communicating with the output port; and a dryer configured to blow dry wind for drying ink on the printed paper into the drying chamber. The dryer is configured to blow the dry wind downstream in the paper conveyance direction in the drying chamber. The dry wind from the dryer is blown to outside the casing through the output port of the casing.

With this configuration, dry wind is blown from the dryer into a downstream portion in the paper conveyance direction of the drying chamber. Accordingly, dry wind strikes paper for a longer time than in a case where the dry wind is blown perpendicularly to the printing surface of the paper. Specifically, in a case where dry wind is blown perpendicularly to the printing surface of paper, the dry wind directly strikes the paper only while the paper faces an exhaust port of the dryer. However, in the above configuration, dry wind is blown downstream in the paper conveyance direction. Accordingly, even when the paper is moved downstream in the paper conveyance direction from the position facing the exhaust port of the dryer, dry wind strikes the paper directly, thereby ensuring a paper drying period as long as possible. As a result, the paper can be efficiently dried.

In addition, dry wind from the dryer blows downstream in the paper conveyance direction without disturbance to be released to outside the casing through the output port of the casing by appropriately setting, for example, the speed of the dry wind. Accordingly, dry wind can also strike paper which is being output to outside the casing through the output port to promote drying, thereby increasing the paper drying period.

Further, the above configuration is preferable because dry wind blowing to outside the casing can reduce heat kept in the drying chamber, and consequently in the casing, and thus, heat transfer from the drying chamber to a unit which is easily affected by heat, such as a back printing unit using an ink ribbon, can be reduced.

In a second aspect of the present invention, in the inkjet printer of the first aspect, an output roller configured to output the printed paper to outside the casing is provided near the output port in the casing, and the output roller includes an air passageway configured to allow dry wind blown downstream in the paper conveyance direction from the dryer to be supplied toward the output port.

The air passageway formed in the output roller can ensure a release of dry wind through the air passageway to the output port, thereby preventing the output roller from hindering blowing of dry wind to outside the casing. Accordingly, even when the output roller is located near the output port, it is possible to ensure that dry wind from the dryer is released to outside the casing.

In a third aspect of the present invention, in the inkjet printer of the second aspect, the output roller includes a roller shaft extending in a width direction of the paper and a plurality of roller parts spaced from each other along an axis of the roller shaft, and the air passageway is provided between each two of the roller parts.

In the above configuration, the air passageway through which dry wind is blown is provided between each two of the roller parts spaced from each other along an axis of the roller shaft. Accordingly, the structure of the air passageway through which dry wind smoothly passes can be simplified.

In a fourth aspect of the present invention, in the inkjet printer of the first aspect, a heat insulating material is provided in an upstream portion of an outer wall of a body of the dryer in the paper conveyance direction.

This configuration can reduce radiation of heat from the outer wall of the dryer body to a unit which is easily affected by heat, such as a back printing unit using an ink ribbon.

In a fifth aspect of the present invention, in the inkjet printer of the first aspect, the casing includes an intake port configured to take air in the casing, the dryer includes an intake unit configured to take air through the intake port and a heating unit configured to heat air taken by the intake unit, and is configured to blow air heated by the heating unit into the drying chamber as the dry wind, and the intake port of the casing is located near the output port.

With this configuration, dry wind (i.e., air) blown through the output port can be introduced through the intake port into the casing before the dry wind is cooled by air outside the casing. Accordingly, the introduced air is heated by the heating unit, and is blown again as dry wind to the drying chamber, thereby advantageously increasing thermal efficiency in heating the introduced air, and as a result, enhancing the drying performance.

In a sixth aspect of the present invention, the inkjet printer of the first aspect further includes a mount part configured to receive, and place thereon, paper output through the output port of the casing, and dry wind blown to outside the casing strikes paper placed on the mount part.

With this configuration, dry wind also strikes paper after the paper has been placed on the mount part. Accordingly, the period during which dry wind strikes paper can be further increased.

In a seventh aspect of the present invention, in the inkjet printer of the sixth aspect, the mount part is part of a conveyance belt configured to convey the paper, and an accumulation device configured to receive, and accumulate therein, paper conveyed by the conveyance belt is provided downstream of the conveyance belt in the paper conveyance direction.

With this configuration, sheets of paper placed on the mount part can be sequentially conveyed to the accumulation device by the conveyance belt, thereby accumulating the paper in the accumulation device. Accordingly, a larger amount of paper can be housed in the accumulation device at a time than in a case where the mount part is made of, for example, the paper output tray. This configuration can reduce the frequency of collecting output paper by the operator, thereby enhancing operating efficiency.

In addition, paper does not overlay previous paper placed on the mount part by appropriately setting the paper conveyance speed of the conveyance belt. Accordingly, even when ink attached to paper on the mount part has not dried yet, it is possible to prevent the ink from being attached to the back surface of next paper, and it is also possible to reduce nonuniformity in drying ink.

In an eighth aspect of the present invention, in the inkjet printer of the seventh aspect, the conveyance belt is driven such that paper placed on the mount part is withdrawn from the mount part before next paper output through the output port of the casing is placed on the mount part.

With this configuration, paper does not overlay previous paper on the mount part. Accordingly, as described above, even when ink attached to paper on the mount part has not dried yet, it is possible to prevent the ink from being attached to the back surface of next paper, and it is also possible to reduce nonuniformity in drying ink. In addition, while paper is being conveyed to the accumulation device, ink on this paper can also be dried.

Here, if paper on the mount part can be withdrawn from the mount part before next output paper is placed on the mount part, the paper conveyance speed of the conveyance belt is preferably reduced as much as possible. Then, it is possible to ensure a period during which dry wind strikes paper on the conveyance belt as long as possible. The conveyance belt is not necessarily driven at a constant speed, and paper may be intermittently conveyed to outside the mount part, i.e., paper already placed on the mount part may be conveyed each time next paper is output.

In a ninth aspect of the present invention, in the inkjet printer of the seventh aspect, the conveyance belt is driven such that paper conveyed by the conveyance belt is fed to the accumulation device at a feed speed equal to or higher than a given speed.

In this configuration, the paper feed speed for feeding paper to the accumulation device is increased. Accordingly, even when a gap is present between the conveyance belt and the paper reception part of the accumulation device, it is possible to prevent paper from entering this gap, thereby ensuring the reception of paper by the accumulation device.

In a tenth aspect of the present invention, in the inkjet printer of the first aspect, the casing includes an intake port through which air is taken in the casing, the dryer includes an intake unit configured to take air through the intake port and a heating unit configured to heat air taken by the intake unit, and is configured to blow air heated by the heating unit into the drying chamber as the dry wind, the casing further includes an exhaust port through which part of dry wind blown into the drying chamber from the dryer is emitted to outside the casing, in addition to the output port, a circulation passageway configured to guide dry wind from the exhaust port to the intake port is provided between the intake port and the exhaust port outside the casing, and part of the dry wind blown from the dryer into the drying chamber is guided to the intake port through the exhaust port and the circulation passageway, whereas the other part of the dry wind is blown to outside the casing through the output port.

With this configuration, part of dry wind blown from the dryer into the drying chamber is guided to the intake port through the exhaust port and the circulation passageway, thereby allowing high-temperature dry wind to return to the dryer. Accordingly, as compared to a case where low-temperature air outside the casing is taken and is subjected to an increase in the temperature of the air, the temperature of intake air can be increased to a required temperature for a short time. As a result, the dryer requires a small amount of thermal energy for increasing the temperature, thereby enabling an efficient increase in the temperature of the dry wind.

In an eleventh aspect of the present invention, the inkjet printer of the tenth aspect, the circulation passageway is made of circulation space formed by an external cover and located inside the external cover, the external cover covers the intake port and the exhaust port, the external cover includes an outside-air inlet through which air is introduced from outside the external cover and the casing into the circulation space, air introduced into the circulation space of the external cover through the outside-air inlet and dry wind emitted through the exhaust port are mixed in the circulation space to form an air mixture, and the air mixture is taken in the casing through the intake port.

With this configuration, air introduced through the outside-air inlet of the external cover and dry wind emitted through the exhaust port are mixed in the circulation space, and the air mixture is heated by the dryer, thereby reducing a variation in temperature distribution in the body of the dryer. As a result, dry wind exhibiting a desired drying ability can be easily produced with stability.

Specifically, if no outside-air inlet is provided in the external cover and only dry wind emitted through the exhaust port is heated by the dryer, the high temperature of this dry wind reduces a period for increasing the temperature of the dry wind in order to obtain a desired drying ability. However, in this case, uneven temperature distribution occurs, i.e., the temperature of the body of the dryer locally increases. When dry wind is blown into the drying chamber in this state, paper does not dry uniformly, resulting in that nonuniformity in drying might occur. However, since dry wind is mixed with outside air in the circulation space as in the above configuration, air is more efficiently diffused in the dryer, and thus uneven temperature distribution is less likely to occur in the dryer. Consequently, dry wind exhibiting a desired drying ability can be easily produced with stability.

In a twelfth aspect of the present invention, in the inkjet printer of the eleventh aspect, the external cover is located above the output port of the casing, and part of dry wind blown to outside the casing through the output port is introduced into the circulation space through the outside-air inlet.

In this configuration, the external cover is located above the output port of the casing, and thus part of dry wind emitted to outside the casing through the output port can be easily introduced into the circulation space. Specifically, if the outside-air inlet is formed in the lower surface of the external cover or near the output port, for example, part of dry wind emitted to outside the casing through the output port naturally blow upward, and thereby enters the circulation space through the outside-air inlet. Since the temperature of dry wind emitted through the output port is lower than that of dry wind emitted through the exhaust port, mixture of the dry wind with dry wind emitted through the exhaust port causes uneven temperature distribution to be less likely to occur in the dryer. On the other hand, the temperature of dry wind emitted through the output port is higher than that of outside air, and thus dry wind exhibiting a desired drying ability can be more efficiently produced.

In addition, the lower surface of the external cover faces paper, and thus dry wind blowing upward is reflected on the lower surface of the external cover to be changed to blow downward, thereby allowing a larger amount of dry wind to strike the paper surface. This can solve a problem in which dry wind is diffused to fail to efficiently strike paper, thereby advantageously promoting drying of paper.

In a thirteenth aspect of the present invention, in the inkjet printer of the twelfth aspect, the outside-air inlet of the external cover is located at a portion of a lower surface of the external cover opposite to the output port of the casing.

With this configuration, it is possible to easily introduce dry wind through the outside-air inlet into the circulation space, while allowing a maximum amount of dry wind to strike the paper surface as much as possible.

In a fourteenth aspect of the present invention, in the inkjet printer of the twelfth aspect, output rollers including an upper roller and a lower roller facing the upper roller are provided near the output port in the casing, and are pressed against each other, and the output rollers are configured to feed the paper obliquely upward with respect to a horizontal direction.

With this configuration, the gap between the lower surface of the external cover and the paper surface can be reduced as much as possible, thereby promoting drying of paper.

Specifically, paper emitted through the output port is generally fed in the horizontal direction, and is placed on the mount part such as a paper output tray disposed below the paper. At this time, the front end of the paper tends to bend down. In particular, in the case of a paper roll wound into a roll, the front end of the paper tends to bend down to a greater extent because the paper curls to round upward. Accordingly, in this case, the gap between the lower surface of the external cover and the paper surface increases, and thus dry wind emitted through the output port is likely to be diffused, resulting in that the paper might not sufficiently dry. However, in the above configuration, paper is fed obliquely upward with respect to the horizontal direction. Thus, even when the front end of the paper bends down, the gap between the lower surface of the external cover and the paper surface can be reduced, and thus dry wind is less likely to be diffused, thereby allowing a lager amount of dry wind to strike the paper surface.

### Advantages of the Invention

In an example inkjet printer according to the present disclosure, a dryer is configured to blow dry wind to a downstream portion in the paper conveyance direction in a drying chamber, and the dry wind from the dryer is emitted to outside a casing through an output port of the casing. This configuration can increase a period during which paper is exposed to dry wind. Accordingly, it is possible to ensure a paper drying period as long as possible without the necessity for reducing the paper conveyance speed.

### BRIEF DESCRIPTION OF THE DRAWINGS

FIG. 1 is a perspective view illustrating an appearance of an inkjet printer according to a first embodiment of the present invention.

FIG. 2 is a perspective view illustrating an internal configuration of a casing of the inkjet printer.

FIG. 3 is a plan view illustrating an internal configuration of the casing of the inkjet printer.

FIG. 4 is a front view illustrating an internal configuration of the casing of the inkjet printer.

FIG. 5 is a left side view illustrating an internal configuration of the casing of the inkjet printer.

FIG. 6 is a back view illustrating an internal configuration of the casing of the inkjet printer.

FIG. 7 is a schematic diagram illustrating a conveyance path of printing paper in the inkjet printer when viewed from the casing left side.

FIG. 8 is a cross-sectional view illustrating a configuration of a drying unit in the casing of the inkjet printer in an enlarged manner when viewed from the casing left side.

FIG. 9 is a plan view illustrating configurations of upstream and downstream output rollers provided near an output port in the casing of the inkjet printer.

FIG. 10 is a perspective view illustrating an appearance of an inkjet printer according to a second embodiment of the present invention.

FIG. 11 is a plan view illustrating the appearance of the inkjet printer of the second embodiment.

FIG. 12 is a view corresponding to FIG. 8 and illustrating an inkjet printer according to a third embodiment of the present invention.

FIG. 13 is a perspective view illustrating a configuration around an output port of the inkjet printer of the third embodiment except for a casing.

FIG. 14 is a perspective view illustrating a configuration of an external cover of the inkjet printer of the third embodiment.

FIG. 15 is a side view schematically illustrating a state in which the front end of a paper roll output through an output port bends down in the inkjet printer of the third embodiment.

FIG. 16 is a view corresponding to FIG. 15 and illustrating a state when relative positions of an upper roller and a lower roller are changed.

### DESCRIPTION OF REFERENCE CHARACTERS

A inkjet printer
H print head
P1 paper sheet
P2 paper roll
R mount part
W dry wind
5 paper output tray (mount part)
6 casing
46 downstream output roller
46a upper roller
46b lower roller
47 output port
48 intake port
49 exhaust port
55 roller shaft
56 roller part
57 air passageway
70 external cover
71 drying chamber
72 dryer
73 intake fans (intake unit)
74 heater (heating unit)
77 heat insulating material
78 dryer body
79 outside-air intake port
80 circulation space (circulation passageway)
100 conveyance unit
101 conveyance belt
110 accumulation unit (accumulation device)

### DESCRIPTION OF EMBODIMENTS

Embodiments of the present disclosure will be described in detail hereinafter with reference to the drawings. The following embodiments are merely examples in nature, and are not intended to limit the scope, applications, and use of the invention.

### Embodiment 1

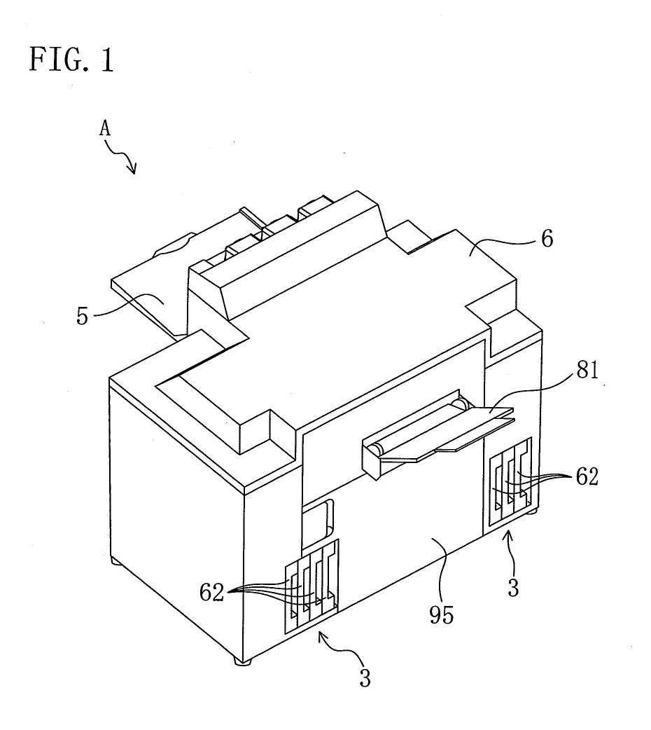

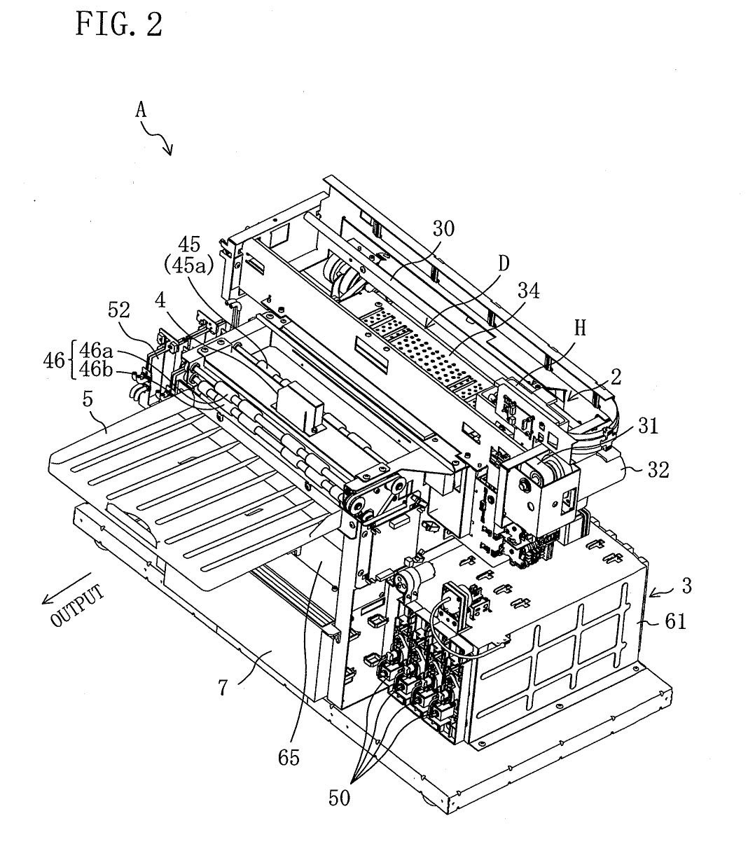

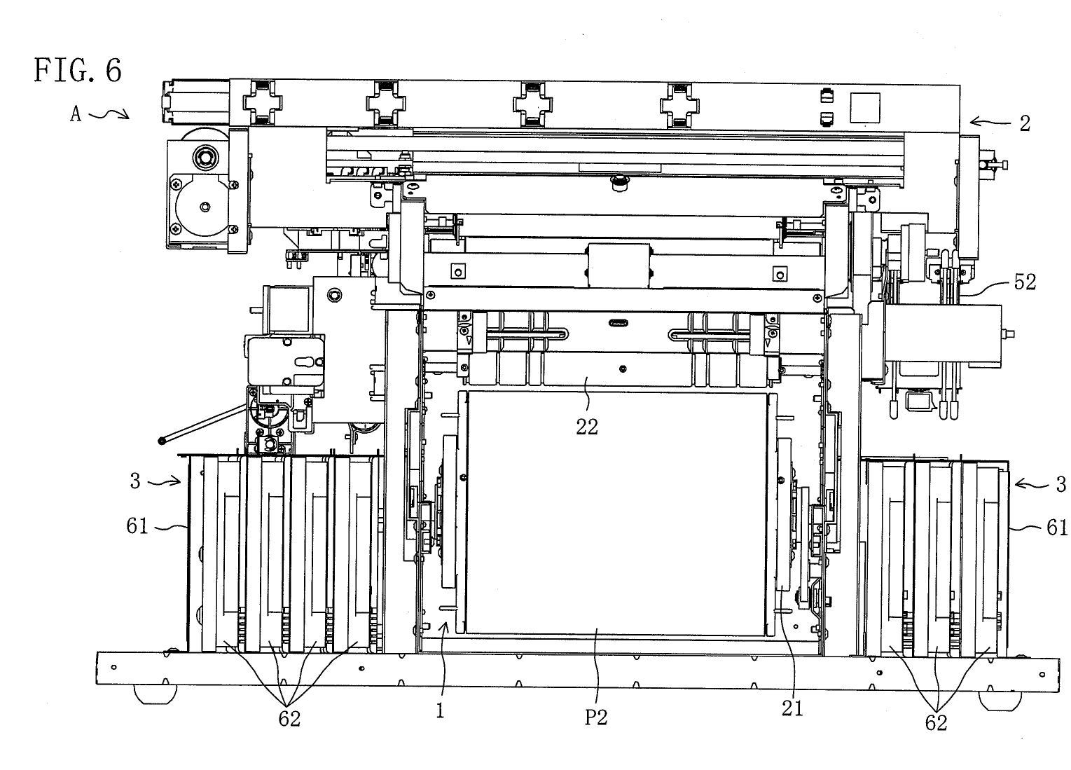

FIG. 1 illustrates an appearance of an inkjet printer A according to a first embodiment of the present invention. FIGS. 2-7 illustrate an internal configuration of the inkjet printer A. This inkjet printer A is used for a photographic printing system, and is used for, for example, printing photographic images on printing paper P1, P2 based on image data transmitted via a communication cable from a reception block for obtaining the image data and correcting the data as necessary. More specifically, the inkjet printer A is configured to perform automatic printing for pulling out one end of a long roll of printing paper P2 (hereinafter referred to as a paper roll P2) and printing an image on the printing surface of the paper roll P2 and manual-feed printing for printing an image on the printing surface of a sheet of printing paper P1 (hereinafter referred to as a paper sheet P1) which is previously cut in a given size.

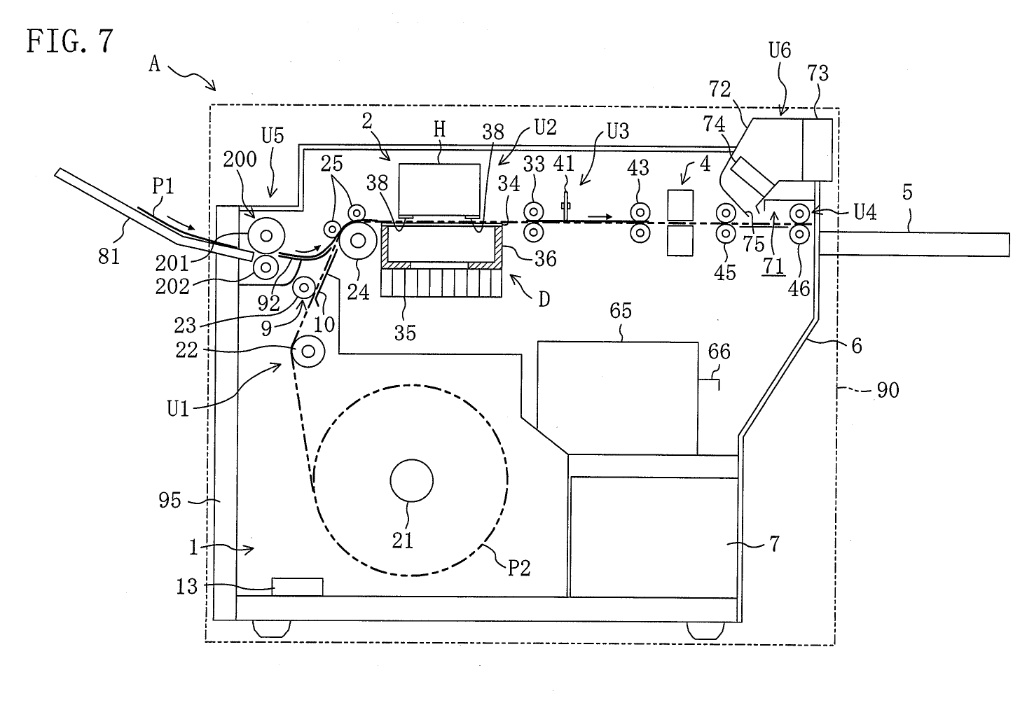

Note that when the paper roll P2 and the paper sheet P1 do not need to be particularly distinguished in the following description, the paper roll P2 and the paper sheet P1 are referred to as printing paper P1 and P2. Furthermore, a “printing surface” means a surface on which an image is to be printed. The printing surface of the paper sheet P1 is determined when the paper sheet P1 is set on a manual-feed tray 81 (see, FIG. 7). Specifically, the printing surface is the surface facing upward when the paper sheet P1 is set on the manual-feed tray 81. On the other hand, the printing surface of the paper roll P2 is the surface facing radially outward when the paper roll P2 is rolled.

### —Overall Configuration—

As shown in FIG. 7, the inkjet printer A includes a printer body 90 and the manual-feed tray 81 for manually setting a paper sheet P1 thereon and feeding the paper sheet P1 to the printer body 90. The printer body 90 includes: a casing 6; a paper-roll housing part 1 defined as a room in a lower portion of the interior of the casing 6 and housing a paper roll P2 rolled with its printing surface facing outward; a printing part 2 disposed in an upper portion of the interior of the casing 6 (i.e., disposed above the paper-roll housing part 1) and configured to print an image, based on image data, on the printing surface of the paper sheet P1 fed from the manual-feed tray 81 or the printing surface of the paper roll P2 pulled out of the paper-roll housing part 1; ink reservoirs 3 (see, FIGS. 1-6) located at both sides of the paper-roll housing part 1 in the lower portion of the interior of the casing 6 and configured to store ink to be supplied to the printing part 2; and a roller unit 200 which is disposed on an upper portion of a cover member 95 attached to the casing 6 to be freely opened and closed, and is configured to convey and feed a paper sheet P1 set on the manual-feed tray 81 toward the printing part 2 when the cover member 95 is closed.

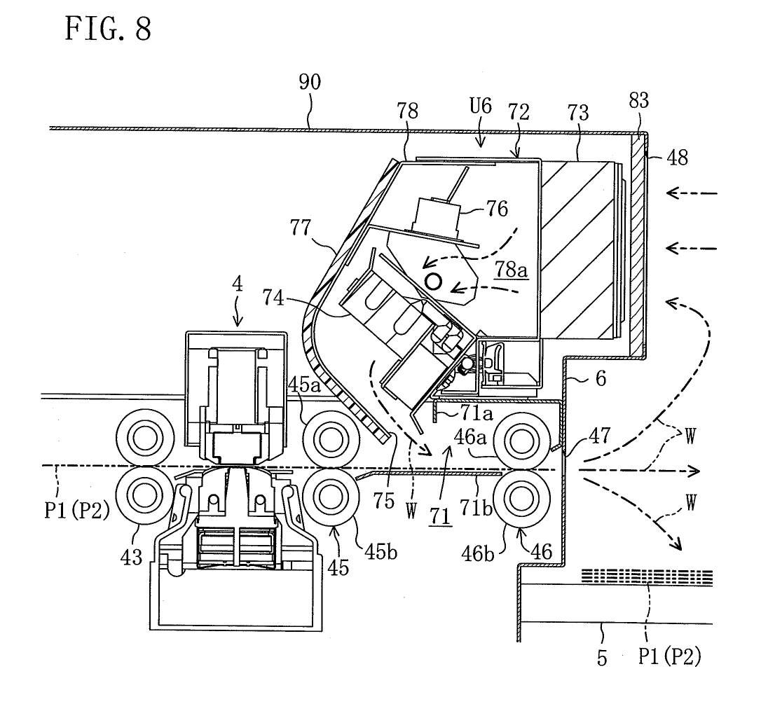

Disposed in the upper portion of the casing 6 and downstream (i.e., at the right side in FIG. 7) of the printing part 2 in the direction of paper conveyance are a roller cutter 41 for cutting the paper roll P2 after printing, a back printing unit 4 for printing a serial number on the back surface of printing paper P1, P2 after printing, a drying unit U6 for drying ink on the printing surface of the printing paper P1, P2 printed in the printing part 2, and upstream and downstream output rollers 45 and 46 for conveying the printing paper P1, P2 printed in the printing part 2 further downstream and outputting the printing paper P1, P2 to the outside. A paper output tray 5 (i.e., a mount part) is disposed downstream of the downstream output roller 46 in the paper conveyance direction to project outward from the front side of the casing 6. This paper output tray 5 is configured to receive, and place thereon, the printing paper P1, P2 output by the upstream and downstream output rollers 45 and 46 to outside the casing 6 through an output port 47 (see, FIG. 8) of the casing 6.

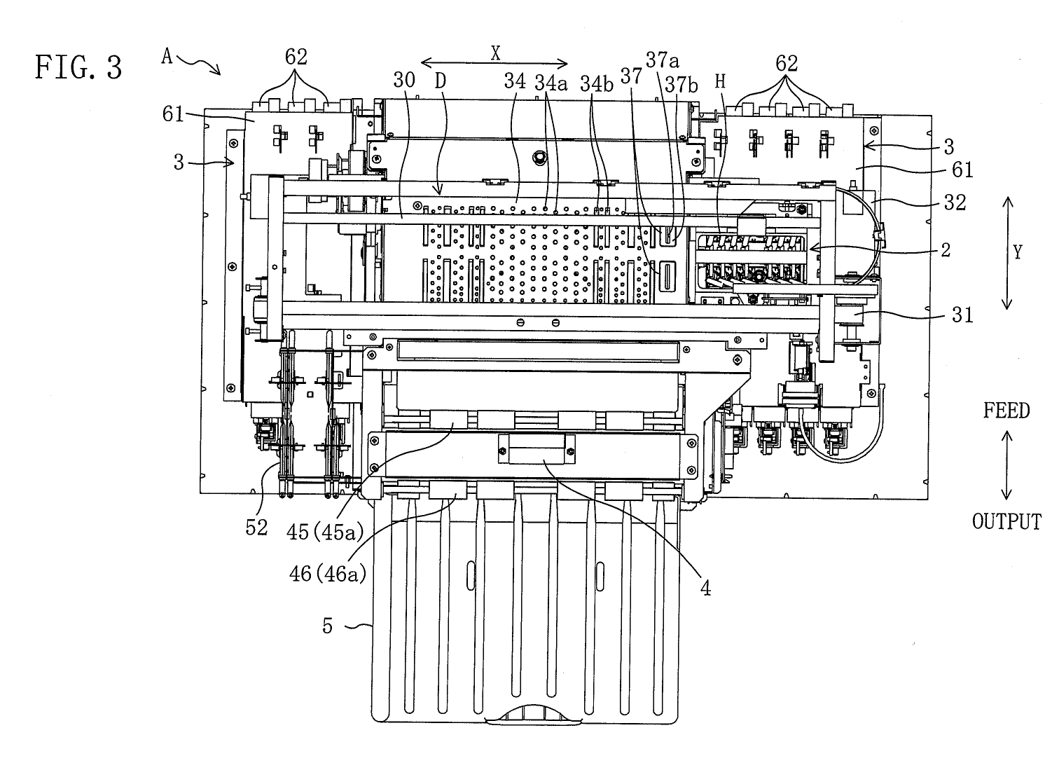

In this embodiment, the side of the casing 6 toward the paper output tray 5 (i.e., the “output” side shown in FIG. 3) is referred to as the casing front side, the side thereof toward the manual-feed tray 81 (i.e., the “feed” side shown in FIG. 3) is referred to as the casing rear side, the left side thereof as viewed from the casing front side is referred to as the casing left side, and the right side thereof as viewed from the casing front side is referred to as the casing right side. Therefore, the right-to-left direction in FIG. 7 is the casing front-to-rear direction, and the direction orthogonal to the drawing sheet of FIG. 7 is the casing right-to-left direction. The casing right-to-left direction coincides with the width direction of the paper sheet P1 set on, and fed from, the manual-feed tray 81 and the width direction of the paper roll P2 housed in, and fed from, the paper-roll housing part 1.

The printing part 2 includes a print head H (see, FIGS. 2-4 and FIG. 7) for ejecting ink therefrom onto the printing paper P1, P2 to form an image on the paper P1, P2. The print head H is movable along a rail 30 extending in a main scanning direction X (see, FIG. 3) which coincides with the width direction of the printing paper P1 or P2 (i.e., the casing right-to-left direction). Specifically, as illustrated in FIGS. 2 and 3, the rotational force of a drive motor 32 is transmitted through a pulley to a drive belt 31, thereby causing the print head H to move in the main scanning direction X according to the amount of rotation of the drive belt 31.

The print head H includes two head units 38 (see, FIG. 7) disposed along a sub-scanning direction Y (see, FIG. 3) orthogonal to the main scanning direction X and coinciding with the direction of travel of the printing paper P1, P2 (i.e., the casing front-to-rear direction). The print head H is configured to print a given image (i.e., an image of image data transmitted from the reception block through the communication cable) on the printing paper P1, P2 by ejecting ink through ink-jet nozzles (not shown) provided in these two head units 38.

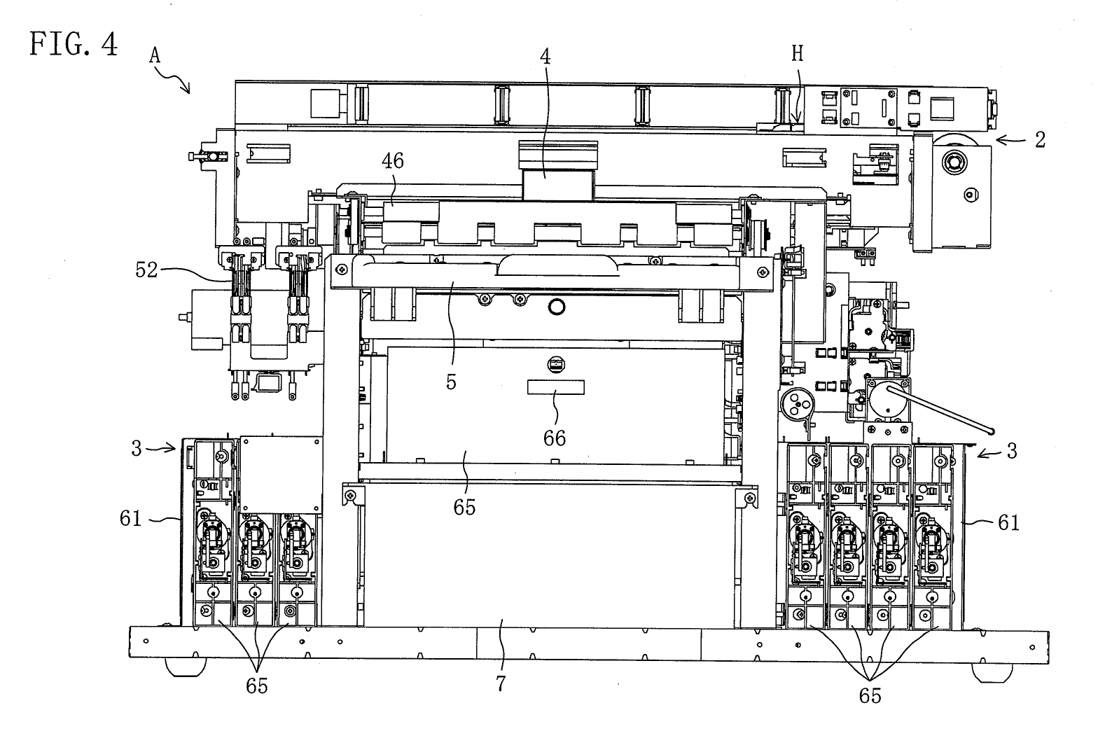

The ink reservoirs 3 respectively include box-shaped cases 61 (see, FIG. 4) disposed on the right and left of the inkjet printer A. These cases 61 contain seven removable ink cartridges 62 in total (where in FIG. 4, three ink cartridges are contained in the left case 61 and four ink cartridges are contained in the right case 61). The ink cartridges 62 are charged with different types of ink having different hues. Therefore, the ink cartridges 62 spent or being used can be replaced with new ones by removing the ink cartridges 62 from the cases 61 and setting new cartridges in the cases 61. Seven types of ink retained in these ink cartridges 62 are yellow (Y), magenta (M), cyan (C), black (K), red (R), violet (V), and clear (CL).

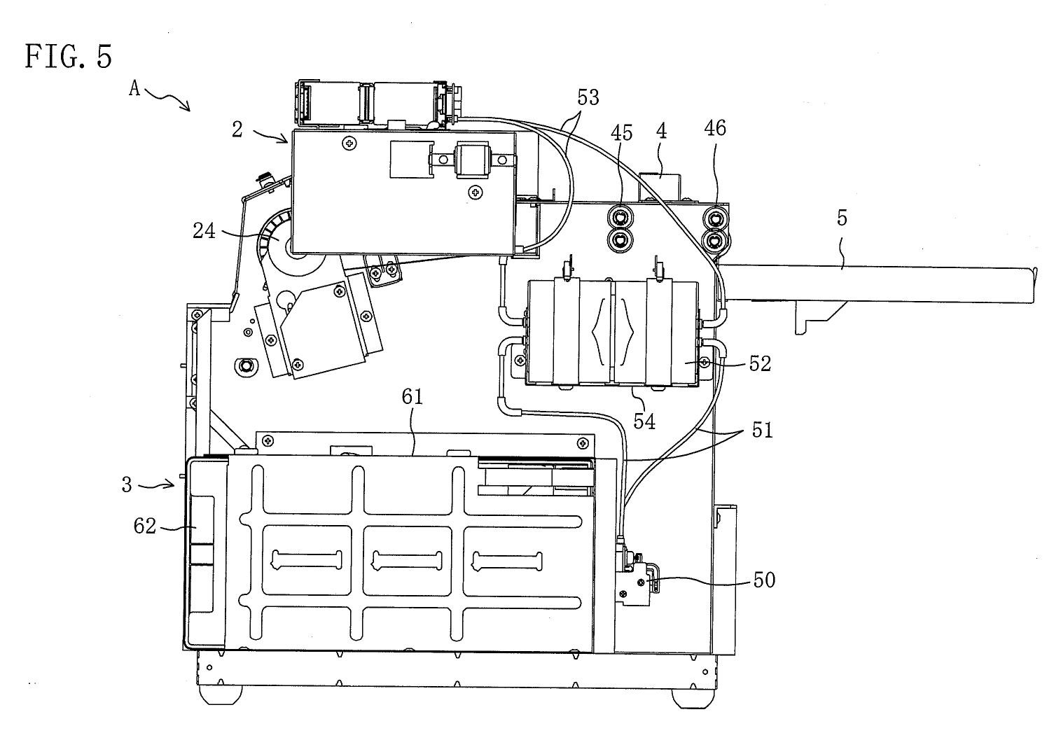

Furthermore, sub-tanks 52 (see, FIGS. 4 and 5) for temporarily storing ink supplied from the ink cartridges 62 are disposed at the casing left side in the casing 6 and at a height between the ink reservoirs 3 and the printing part 2. These sub-tanks 52 are connected to the print head H of the printing part 2, and are configured to supply ink to the print head H under a negative pressure produced in ejecting the ink through the nozzles of the print head H.

### —Paper Conveyance Mechanism—

As shown in FIG. 7, the inkjet printer A includes a paper conveyance mechanism for pulling in a paper roll P2 from the paper-roll housing part 1 and conveying the paper roll P2 along a given conveyance path. To form the paper conveyance path, the paper conveyance mechanism includes, in order from a feed unit U1 for feeding the paper roll P2, the feed unit U1, a printing unit U2, a cutter unit U3, the drying unit U6, and a paper output unit U4. Image data is printed on the printing surface of printing paper P1, P2 located on the paper conveyance path in the printing unit U2 of the printing part 2.

In this embodiment, for another paper feed path in addition to the feed path of a paper roll P2 from the feed unit U1 to the printing unit U2, the paper conveyance mechanism further includes a manual-feed unit U5 configured to pull a paper sheet P1 from the manual-feed tray 81 and feed the paper sheet P1 to the printing part 2.

In the case of printing on a paper roll P2, in the paper conveyance mechanism, the feed unit U1 feeds a paper roll P2 set in the paper roll housing part 1 to the printing unit U2 (i.e., the printing part 2), and the printing unit U2 then prints image data with the print head H during conveyance of the paper roll P2. The printed paper roll P2 is conveyed to the cutter unit U3, and the cutter unit U3 cuts the paper roll P2 into a given print size. Thereafter, the drying unit U6 dries ink attached to the paper roll P2 by the printing, and the paper output unit U4 sends the paper roll P2 to the paper output tray 5.

On the other hand, in the case of printing on a paper sheet P1, in the paper conveyance mechanism, the manual-feed unit U5 conveys a paper sheet P1 set on the manual-feed tray 81 to the printing unit U2 (i.e., the printing part 2), and the same processes as those for the paper roll P2 are performed except that the paper sheet P1 is not cut with the cutter unit U3 in usual cases.

The manual-feed unit U5 includes the roller unit 200 for guiding the paper sheet P1 to the printing part 2. This roller unit 200 includes a drive roller 202 and a driven roller 201. The manual-feed unit U5 guides the paper sheet P1 from the manual-feed tray 81 into the printer body 90 by driving the drive roller 202 into rotation.

The feed unit U1 includes: a core roller 21 for winding a paper roll P2 into a roll to house the rolled paper roll P2 in the paper-roll housing part 1; a transverse restriction roller 22 for determining a transverse position of the paper roll P2 pulled out of the core roller 21; a closing roller 23 which will be described later; a conveyance drive roller 24 capable of being driven into rotation by an electric motor (not shown) to convey the paper roll P2; and two pressing rollers 25 opposed to the conveyance drive roller 24 and pressed against the conveyance drive roller 24 to engage the paper roll P2 together with the conveyance drive roller 24.

The feed unit U1 is configured to pull the paper roll P2 out of the paper-roll housing part 1 and also feed the paper roll P2 to the printing part 2 by rotation of the conveyance drive roller 24. In this embodiment, although the feed unit U1 includes the transverse restriction roller 22, the transverse restriction roller 22 may be replaced with a guide for determining the transverse position of the paper roll P2.

The closing roller 23 is provided to ensure airtightness of the paper-roll housing part 1 and thereby prevent the interior of the paper-roll housing part 1 from falling into a low-humidity condition. Specifically, the walls defining the paper-roll housing part 1 partially need to have a paper lead-out opening 9 for leading the paper roll P2 out of the paper-roll housing part 1 to outside the paper-roll housing part 1 in the interior of the casing 6 (i.e., to the space thereof containing the printing part 2). If the paper lead-out opening 9 would remain open, the airtightness of the paper-roll housing part 1 could not be ensured. In view of this, the paper lead-out opening 9 is provided with the closing roller 23 which closes the paper lead-out opening 9 to allow the paper roll P2 to pass therethrough.

At least the outer peripheral part of the closing roller 23 is made of an elastically deformable material, such as foam including sponge or rubber. The closing roller 23 is configured to be in contact with the paper roll P2 passing through the paper lead-out opening 9 while elastically deforming radially inwardly, and to be thereby driven into rotation. During the contact, the paper roll P2 is pressed against a guide member 10 disposed opposite to the closing roller 23 (having a substantially small pressing force) with a paper conveyance path sandwiched therebetween. Thus, the paper roll P2 can pass through the paper lead-out opening 9 with little resistance from the closing roller 23 with airtightness of the paper-roll housing part 1 maintained.

The closing roller 23 may be configured to act as a drive roller for intentionally feeding or rewinding the paper roll P2. The rotation of this closing roller 23 may be implemented by transmitting a rotational driving force of the conveyance drive roller 24 to the closing roller 23 with, for example, a solenoid clutch (not shown). Then, no additional electric motor needs to be provided, which is advantageous in space saving and cost reduction of the printer.

On the other hand, when the paper roll P2 is not present in the paper lead-out opening 9, the closing roller 23 is in contact with the guide member 10. In this case, the airtightness of the paper-roll housing part 1 can also be ensured. In this paper-roll housing part 1, a container 13 containing water and opening at its top is disposed. The water in the container 13 vaporizes, and thus the interior of the paper-roll housing part 1 is efficiently humidified.

Thus, even when the inkjet printer A itself is put under low-humidity conditions for a long time, the interior of the paper-roll housing part 1 can be kept at an appropriate humidity (i.e., a relative humidity range of 30% to 75%, preferably 40% to 60%), thereby preventing the paper roll P2 from producing such a curl that a widthwise middle portion of the printing surface of the paper roll P2 rises with respect to both widthwise ends thereof.

The conveyance drive roller 24 is configured to be rotated forward by an electric motor (not shown) to pull the paper roll P2 out of the paper-roll housing part 1 and feed the paper roll P2 to the printing part 2, and rotated backward by the electric motor to return the paper roll P2 to the paper-roll housing part 1.

Thus, the inkjet printer A can cut a printed portion of the paper roll P2 into a given size with the cutter unit U3 located downstream of the printing part 2, and return a long portion of the paper roll P2 remaining after the cutting to an upstream portion to restart printing with the leading edge of the remaining paper roll P2, or can return the paper roll P2 after the cutting into the paper-roll housing part 1, and feed a single paper sheet P1 to the printing part 2 through the manual-feed unit U5 to print an image on the paper sheet P1. Furthermore, in replacing the paper roll P2 with new one, the paper roll P2 pulled out of the paper-roll housing part 1 can be returned into the paper-roll housing part 1.

The printing unit U2 includes: a paper holder D (see, FIGS. 2, 3, and 7) for holding, by suction, the printing paper P1, P2 at a position allowing printing with the print head H; and paper conveyance rollers 33 disposed downstream of the paper holder D and pressed against each other. The conveyance drive roller 24 and the pressing rollers 25 in the feed unit U1 are also used as components of the printing unit U2, and act to convey the printing paper P1, P2 in the printing unit U2.

The paper holder D includes: a platen 34 having suction holes 34a (see, FIG. 3) formed at the surface (i.e., the top) of the platen 34; and a fan 35 (see, FIG. 7) for sucking the printing paper P1, P2 fed onto the platen 34 by the feed unit U1, through the suction holes 34a and thereby holding, by suction, the printing paper P1, P2 on the surface of the platen 34. The platen 34 is composed of a plate-shape material. A case 36 forming space together with the platen 34 is disposed on the back surface (i.e., the bottom) of the platen 34. The fan 35 is disposed under the case 36. The suction holes 34a are formed through the platen 34 in the thickness direction, and communicate with the space in the case 36. The space in the case 36 communicates with the inlet opening of the fan 35 through an opening formed in the bottom of the case 36. When the fan 35 is operated, a negative pressure is produced through the suction holes 34a in the surface of the platen 34, resulting in that the printing paper P1, P2 is held on the surface of the platen 34 by suction.

The platen 34 further includes: flashing parts 37 (see, FIG. 3) for receiving a small amount of ink ejected through the ink jet nozzles in the head units 38 of the print head H to prevent the viscosity of the ink from increasing in printing; and caps (not shown) disposed at a standby position of the print head H while the inkjet printer A is halted, and configured to cover the ink-jet nozzles in the head units 38 of the print head H to prevent the ink viscosity from increasing.

Each of the flashing parts 37 includes an opening 37a (see, FIG. 3) formed in the platen 34 and a case (not shown) forming space communicating with the opening 37a and disposed below the opening 37a of the platen 34. The case communicates with a waste tank 7 (see, FIGS. 2, 4, and 7) disposed in a lower portion of the casing 6 toward the casing front side in the inkjet printer A. Furthermore, an ink absorbing material 37b made of sponge capable of absorbing ink is disposed in the opening 37a. The ink absorbed in the ink absorbing material 37b accumulates in the space in the case located below the associated flashing part 37. Thus, the ink ejected toward the openings 37a of the flashing parts 37 is led into the waste tank 7 after accumulating in the space in the case.

Although not specifically shown, each cap is configured to form space subjected to a negative pressure to draw a slight amount of ink through the ink-jet nozzles into the space when the cap covers the bottom surface of the print head H. Thus, it is possible to reduce difficulty in ejecting ink due to an increased viscosity of the ink in the ink-jet nozzles.

The print head H includes the two head units 38 having a plurality of ink-jet nozzles and disposed in two stages in the sub-scanning direction Y on the bottom thereof (i.e., the surface facing the platen 34), as described previously. However, the number of head units 38 is not necessarily two, and may be one, or may be three or more.

Both the head units 38 have the same structure, and each of the head units 38 is composed of seven nozzle arrays arranged in the main scanning direction X and used for ejecting different types of ink associated with different colors. In each of the nozzle arrays, the ink-jet nozzles described above are aligned in the sub-scanning direction Y. Thus, each of the head units 38 can provide color images independently of each other. The printing paper P1, P2 is intermittently (i.e., stepwise) conveyed in certain unit amounts of conveyance in the sub-scanning direction Y by the conveyance drive roller 24. During each stopping time of the printing paper P1, P2 in the intermittent conveyance, the print head H scans in one way (i.e., performs a forward scanning or a backward scanning) in the main scanning direction X. During the scanning, different types of ink of different colors are concurrently ejected through the associated ink jet nozzles of each head unit 38 onto the printing surface of the printing paper P1, P2 at positions in the main scanning direction X. In other words, after a single scanning of the print head H, the printing paper P1, P2 is conveyed by a unit amount of conveyance, and the print head H then scans once. By repeating this operation, a desired image is printed. In this embodiment, in order to eject ink from the print head H, a general piezoelectric technique in which the volume of a pressure chamber charged with ink is changed by a piezoelectric element and ink is thereby ejected through the ink-jet nozzles communicating with the pressure chamber, is employed.

The cutter unit U3 includes a roller cutter 41, and is configured to cut the printing paper P1, P2 into a given size (i.e., length) by moving the roller cutter 41 in the width direction at an appropriate position of the length of the printing paper P1, P2 while rotating the roller cutter 41. A chip collecting box 65 for collecting chips of the printing paper P1, P2 formed by the cutting is disposed below the roller cutter 41. The chip collecting box 65 allows the operator to slide the chip collecting box 65 out of the casing 6 by pulling its handle 66 in order to discard the chips collected in the chip collecting box 65. The casing front side of the chip collecting box 65 is made of a clear plastic material to enable visual inspection for collection of chips.

Furthermore, the cutter unit U3 is configured to convey the printing paper P1, P2 to the paper output unit U4 with the conveyance rollers 43 pressed against each other. The back printing unit 4 is disposed between the cutter unit U3 and the paper output unit U4. In the back printing unit 4, a serial number or the like is printed on the back surface (i.e., the lower surface) of the printing paper P1, P2 passing through the back printing unit 4.

The paper output unit U4 includes the two pairs of upstream and downstream output rollers 45 and 46 for conveying the printing paper P1, P2 after printing and for delivering the printing paper P1, P2 to the paper output tray 5. The downstream output roller 46 is disposed near the output port 47 in the casing 6.

As illustrated in FIG. 8, each set of the upstream and downstream pressing output rollers 45 and 46 is made of rollers pressed against each other, and includes an upper roller 45a, 46a pressed against the printing surface of the printing paper P1, P2 and a lower roller 45b, 46b facing the upper rollers 45a, 46a and pressed against the back surface of the printing paper P1, P2.

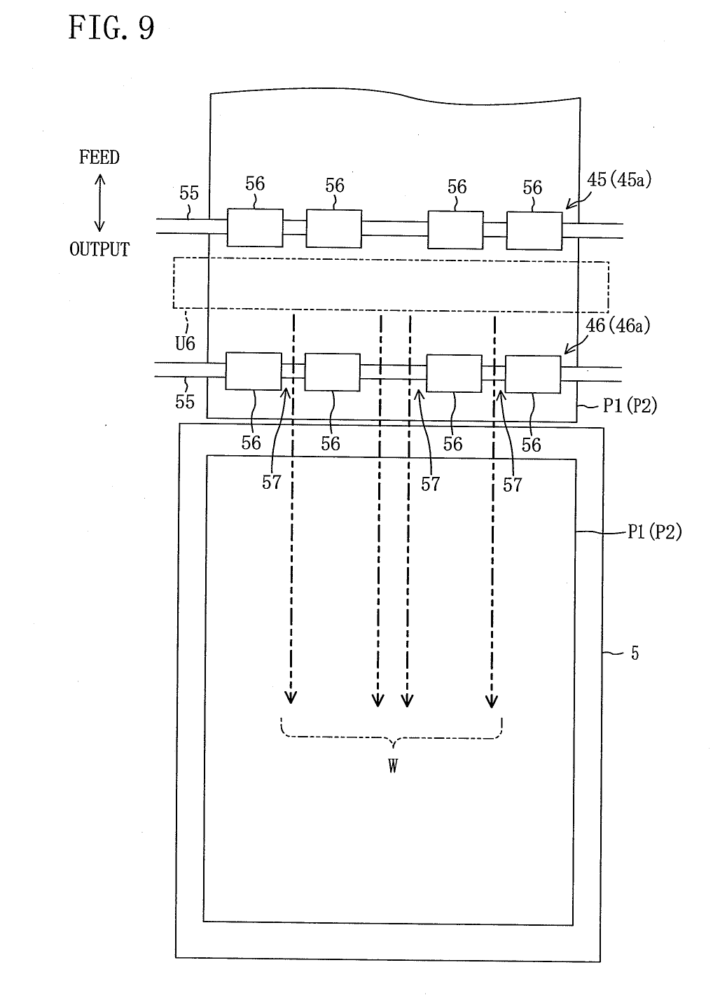

As illustrated in FIG. 9, each of the upper roller 45a, 46a and the lower roller 45b, 46b includes: a roller shaft 55 extending in the width direction of the printing paper P1, P2; and a plurality of roller parts 56 spaced apart from each other along the axis of the roller shaft 55. The diameter of a portion of the roller shaft 55 between adjacent ones of the roller parts 56 of each of the upper and lower rollers 46a and 46b of the downstream output roller 46 is smaller than the diameter of the roller parts 56, thereby forming air passageways 57 allowing dry wind W (see, FIGS. 8 and 9) supplied from a dryer 72, which will be described below, to blow toward the output port 47 of the casing 6.

The drying unit U6 is disposed between two pairs of the output rollers 45 and 46 of the paper output unit U4. As illustrated in FIG. 8, this drying unit U6 includes: a drying chamber 71 located downstream, in the paper conveyance direction, of the print head H on the paper conveyance path in the casing 6; and a dryer 72 for supplying dry wind W to the drying chamber 71 to dry ink on the printing paper P1, P2 after printing. The drying chamber 71 is defined by an upper partition wall 71a and a lower partition wall 71b which are opposed to each other while sandwiching the printing paper P1, P2 between the output rollers 45 and 46, and communicates with the output port 47.

The dryer 72 includes: a body 78 in which an air path 78a is provided; intake fans 73 (i.e., an intake unit) for taking air in the casing 6 through an intake port 48 of the casing 6 from outside the casing 6 and introducing the air in the body 78; a dust collection filter 83 provided between the intake port 48 and the intake fans 73 and used for preventing dust in the air from entering the dryer 72; a heater 74 (i.e., a heating unit) provided in the body 78 (i.e., the air path 78a) and used for heating the air taken in the body 78 by the intake fans 73; an exhaust nozzle 75 which is disposed at the lower end (i.e., in an upstream portion in the paper conveyance direction of the drying chamber 71) of the body 78 and is open toward a downstream portion in the paper conveyance direction; and a safety thermostat 76 for detecting the internal temperature of the body 78 and stopping the heater 74 in an emergency situation. The intake port 48 is open near an upper portion of the output port 47 at the front side surface of the casing 6.

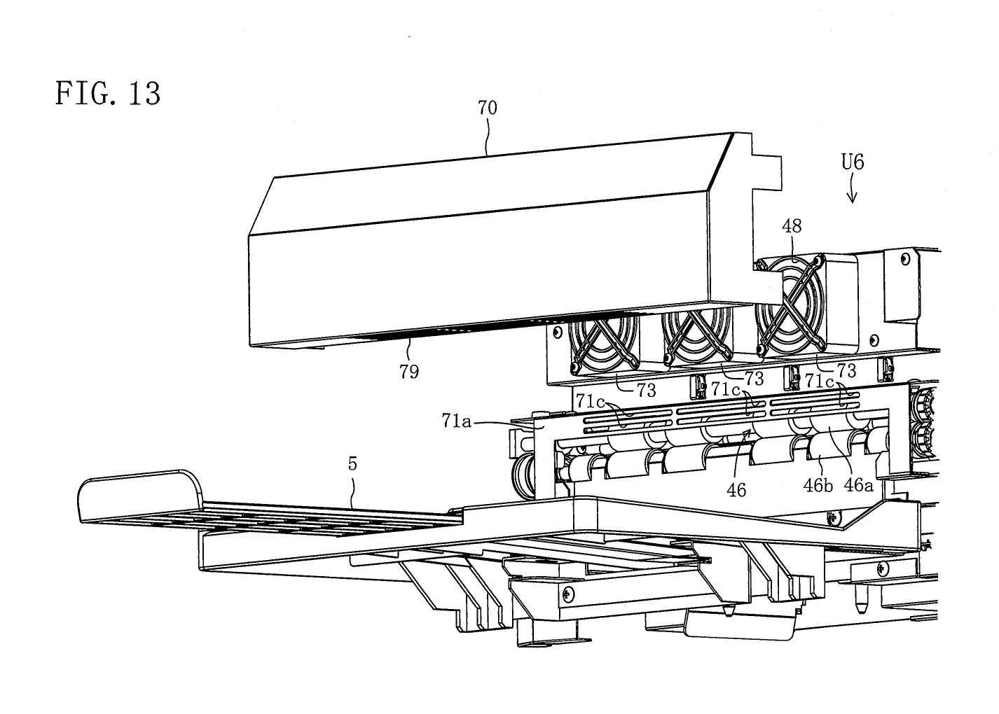

The intake fans 73 are spaced from each other along the casing right-to-left direction (see, FIG. 13 showing a periphery of an output port 47 in an inkjet printer A according to a third embodiment which will be described later). In the dryer 72, the heater 74 heats air taken in the body 78 by the intake fans 73, and the air heated by the heater 74 is blown as dry wind W into the drying chamber 71 through the exhaust nozzle 75. The opening of the exhaust nozzle 75 is oriented such that the dry wind W is blown toward a downstream portion in the paper conveyance direction in the drying chamber 71.

A heat insulating material 77 is attached to the entire upstream portion of the outer wall of the body 78 of the dryer 72 in the paper conveyance direction. The heat insulating material 77 can reduce radiation of heat from the outer wall of the body 78 of the dryer 72, to a unit which is easily affected by heat, such as the back printing unit 4 using an ink ribbon, and which is provided upstream in the paper conveyance direction.

As illustrated in FIG. 9, dry wind W blown downstream in the paper conveyance direction through the exhaust nozzle 75 of the dryer 72 passes through the air passageways 57 of the downstream output roller 46 to be brown to outside the casing 6 through the output port 47. The speed of dry wind W blown from the exhaust nozzle 75 is set such that the dry wind W is brown to outside the casing 6 through the output port 47 in the manner described above.

In this embodiment, dry wind W blown to outside the casing 6 strikes the printing paper P1, P2 on the paper output tray 5. Specifically, although dry wind W blown to outside the casing 6 is diffused vertically, part of the dry wind W blowing downward strikes the printing paper P1, P2 on the paper output tray 5. On the other hand, part of the dry wind W blowing upward is introduced into the body 78 of the dryer 72 in the casing 6 through the intake port 48 provided near the output port 47. Air introduced into the body 78 through the intake port 48 includes cold air (e.g., outside air) in addition to the dry wind W blown to outside the casing 6.

To cause the part of the dry wind W emitted to outside the casing 6 and blowing upward to blow downward (i.e., toward printing paper P1, P2 on the paper output tray 5), a reflection member for reflecting dry wind W may be provided on a portion of the casing 6 located above the output port 47. To increase an amount of dry wind W striking printing paper P1, P2 on the paper output tray 5, the paper output tray 5 may be inclined upward toward the side opposite to the casing 6, or the opening of the output port 47 may be oriented obliquely downward.

However, dry wind W blown to outside the casing 6 does not need to strike printing paper P1, P2 on the paper output tray 5 if ink on the printing paper P1, P2 dries before placement of the printing paper P1, P2 on the paper output tray 5 is completed.

The drying unit U6 described above causes dry wind W to blow to a downstream portion in the paper conveyance direction, thereby increasing a period during which the dry wind strikes printing paper P1, P2 in the drying chamber 71. This can promote drying of ink ejected onto the printing paper P1, P2 from the print head H.

In addition, since dry wind W is blown to outside the casing 6 through the air passageways 57 of the output rollers 46 and the output port 47 of the casing 6, it is also possible to promote drying, with dry wind W, of printing paper P1, P2 being supplied to outside the casing 6 through the output port 47.

Further, since dry wind W blown to outside the casing 6 through the output port 47 strikes printing paper P1, P2 on the paper output tray 5, the dry wind W can strike the printing paper P1, P2 for a longer time.

Moreover, since the intake port 48 for taking air in the dryer 72 is formed near a portion above the output port 47 through which dry wind W is blown, dry wind (i.e., air) blown through the output port 47 can be introduced through the intake port 48 into the body 78 of the dryer 72 in the casing 6 before the dry wind is cooled by air outside the casing 6. Accordingly, advantageously, thermal efficiency in heating the introduced air with the heater 74 can be increased, thereby enhancing the drying performance.

### —Ink Supply System—

As shown in FIG. 5, the ink supply system of the inkjet printer A is configured to deliver ink contained in the ink cartridges 62 of the ink reservoirs 3 disposed on both lateral sides of the inkjet printer A via solenoid valves 50 and delivery tubes 51 to the sub-tanks 52, and to supply the ink in the sub-tanks 52 via flexible tubes 53 to the print head H.

The ink is delivered from the ink cartridges 62 to the sub-tanks 52 by pressurized air supplied into the ink cartridges 62 by a pressure pump (not shown), and then flows from the sub-tanks 52 to the print head H under a negative pressure produced in pressure chambers upon ink ejection through the nozzles of the print head H.

Each of the sub-tanks 52 is formed in the shape of a bag using a flexible material such as a resin sheet. The number of sub-tanks 52 is seven to correspond to the number (i.e., seven) of ink types having different hues. The seven sub-tanks 52 are disposed at a given height in relation to the print head H so that the ink can be supplied under an appropriate pressure to the print head H.

As described above, the ink from the ink cartridges 62 is once stored in the sub-tanks 52, and then supplied from the sub-tanks 52 to the print head H. Therefore, the ink cartridges 62 can be replaced with new ones without interruption of printing. Furthermore, since the sub-tanks 52 also act as pressure dampers, it is possible to prevent pressure variations in the ink cartridges 62 from being directly transmitted to the print head H and in turn prevent an excessive pressure from being applied to the print head H to cause problems, such as ink leakage.

As described above, the inkjet printer A of the first embodiment is configured such that the dryer 72 of the drying unit U6 blows dry wind W downstream in the paper conveyance direction in the drying chamber 71, thereby increasing a period during which dry wind W strikes printing paper P1, P2 after printing in the drying chamber 71. In addition, the dry wind W is also blown to outside the casing 6 through the output port 47. This causes the dry wind W to also strike printing paper P1, P2 which is being output through the output port 47, thereby efficiently drying the printing paper P1, P2. Consequently, when the printing paper P1, P2 is output on the paper output tray 5, ink on the printing paper P1, P2 is already dry without the necessity for reducing the conveyance speed of the printing paper P1, P2. As a result, even when additional printing paper P1, P2 output from the output port 47 is placed on the previous printing paper P1, P2, problems, such as color unevenness of an printed image and unwanted adhesion of ink, do not occur.

### Embodiment 2

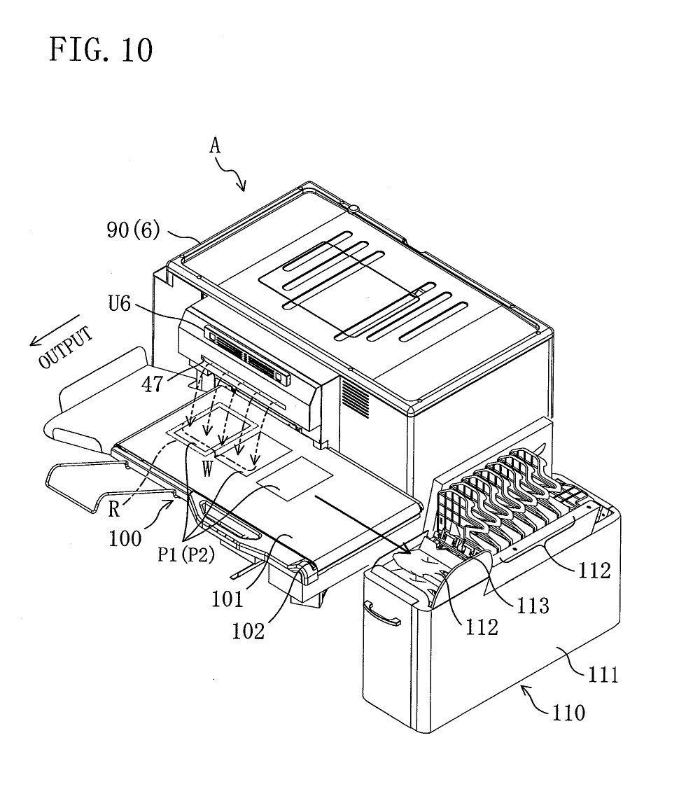

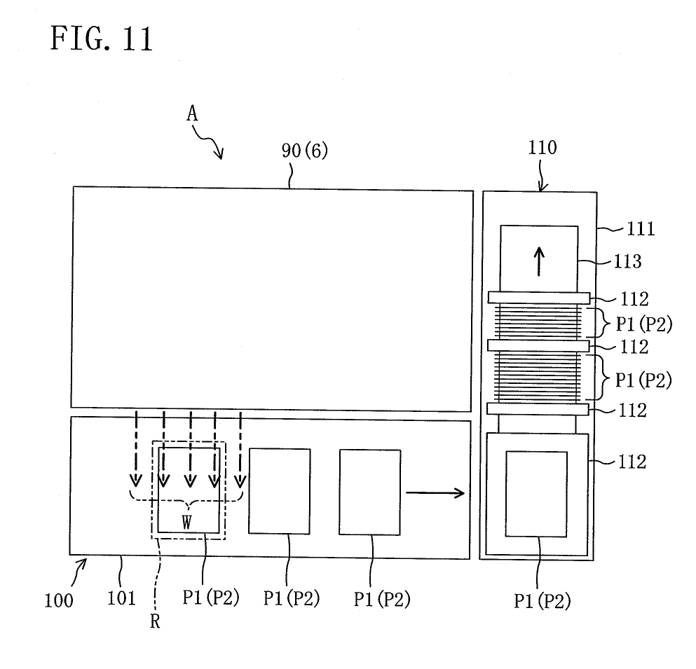

FIGS. 10 and 11 illustrate an inkjet printer A according to a second embodiment of the present invention. The inkjet printer A of the second embodiment is different from that of the first embodiment only in that the paper output tray 5 is replaced with a conveyance unit 100 and an accumulation unit 110.

The inkjet printer A includes: a printer body 90; a conveyance unit 100 disposed at the casing front side of the printer body 90; and an accumulation unit 110 (i.e., an accumulation device) disposed at the casing right side of the conveyance unit 100.

The printer body 90 has a similar structure as that described in the first embodiment. Specifically, a dryer 72 of a drying unit U6 blows dry wind W downstream in a drying chamber 71, and this dry wind W is blown through the output port 47.

The conveyance unit 100 is provided instead of the paper output tray 5 of the first embodiment, and receives, and places thereon, printing paper P1, P2 output from an output port 47 of a casing 6 of the printer body 90. The conveyance unit 100 includes: a conveyance belt 101 serving as a conveyor belt for conveying the printing paper P1, P2 placed in the conveyance unit 100 to the side (i.e., the casing right side) at which the accumulation unit 110 is disposed; and a drive roller 102 for driving the conveyance belt 101.

Part of the conveyance belt 101, i.e., part of the conveyance belt 101 below the output port 47, serves as a mount part R for receiving, and placing thereon, printing paper P1, P2 output from the output port 47. In the same manner as in the first embodiment, dry wind W from the output port 47 strikes the printing paper P1, P2 placed on the mount part R.

The conveyance belt 101 is driven to withdraw printing paper P1, P2 on the mount part R before next printing paper P1, P2 from the output port 47 is placed on the mount part R. This can prevent printing paper P1, P2 from overlaying another printing paper P1, P2 on the conveyance belt 101. Accordingly, even when ink attached to printing paper P1, P2 on the mount part R does not dry, it is possible to prevent the ink from being attached to the back surface of the next printing paper P1, P2, and it is also possible to reduce nonuniformity in drying the ink. In addition, while printing paper P1, P2 is being conveyed to the accumulation unit 110, ink on this printing paper P1, P2 can be dried.

The conveyance belt 101 is preferably driven at such a conveyance speed that next printing paper P1, P2 is not output until a short time (i.e., such a period that provides small space between adjacent sheets of printing paper P1, P2 on the conveyance belt 101) is elapsed after the previous, i.e., already placed, printing paper P1, P2 has been completely withdrawn from the mount part R. In this manner, the conveyance speed of the conveyance belt 101 is reduced as much as possible, thereby allowing dry wind W to be blown to the printing paper P1, P2 on the conveyance belt 101 for a longer time. It should be noted that, in the case of continuously driving the conveyance belt 101 at a constant speed, the conveyance speed for the printing paper P1, P2 may exceed a given speed in consideration of a paper feed speed for printing paper P1, P2 to the accumulation unit 110 as described later.

The conveyance belt 101 does not need to be continuously driven at a constant speed, and printing paper P1, P2 may be intermittently conveyed to outside the mount part R, i.e., printing paper P1, P2 already placed on the mount part R may be conveyed each time next printing paper P1, P2 is output.

The accumulation unit 110 is disposed downstream of the conveyance belt 101 in the paper conveyance direction, receives and accumulates printing paper P1, P2 conveyed from the conveyance unit 100. This accumulation unit 110 includes: an accumulation body 111; a plurality of accumulation plates 112 provided in the accumulation body 111, spaced from one another, and configured to receive printing paper P1, P2 conveyed from the conveyance unit 100; and an accumulation belt 113 serving as a conveyor belt for conveying the accumulation plates 112 to the casing rear side.

One of the accumulation plates 112 is held on standby at a reception position downstream of the conveyance belt 101 in the paper conveyance direction with the plate surface being horizontally oriented and being substantially flush with the belt surface of the conveyance belt 101, and then receives printing paper P1, P2 fed from the conveyance belt 101. After multiple sheets of printing paper P1, P2 in a number corresponding to a given order for printing have been accumulated in one of the accumulation plates 112 at the reception position, this plate 112 is carried to the casing rear side by the accumulation belt 113 before printing paper P1, P2 for the next order comes. With this conveyance, the horizontally held accumulation plate 112 rises in the course of the conveyance by the accumulation belt 113, and acts as a partition for partitioning printing paper P1, P2 for every order for printing.

Here, the conveyance belt 101 is preferably driven such that the feed speed (i.e., the paper conveyance speed) for printing paper P1, P2 is higher than or equal to a given speed when the printing paper P1, P2 is fed from the conveyance belt 101 to the accumulation unit 110 (i.e., the accumulation plate 112 at the reception position). That is, since the gap is present between the conveyance belt 101 and the accumulation plate 112, if the feed speed described above is excessively low, the front end of the printing paper P1, P2 might enter this gap, resulting in that the accumulation plate 112 at the reception position might fail to receive the printing paper P1, P2. To prevent this, the feed speed is controlled to be equal to or higher than a speed at which the accumulation plates 112 can receive the printing paper P1, P2 with stability, thereby ensuring the reception of printing paper P1, P2 by the accumulation plate 112.

As described above, in the inkjet printer A of the second embodiment, printing paper P1, P2 output from the output port 47 is placed on the mount part R of the conveyance belt 101 of the conveyance unit 100, and then is withdrawn from the mount part R before the next printing paper P1, P2 is placed on the mount part R. Accordingly, dry wind W from the output port 47 can strike printing paper P1, P2 on the conveyance belt 101 for a long time. In addition, it is possible to prevent the printing paper P1, P2 from overlaying another printing paper P1, P2. As a result, printing paper P1, P2 can be efficiently dried.

### Embodiment 3

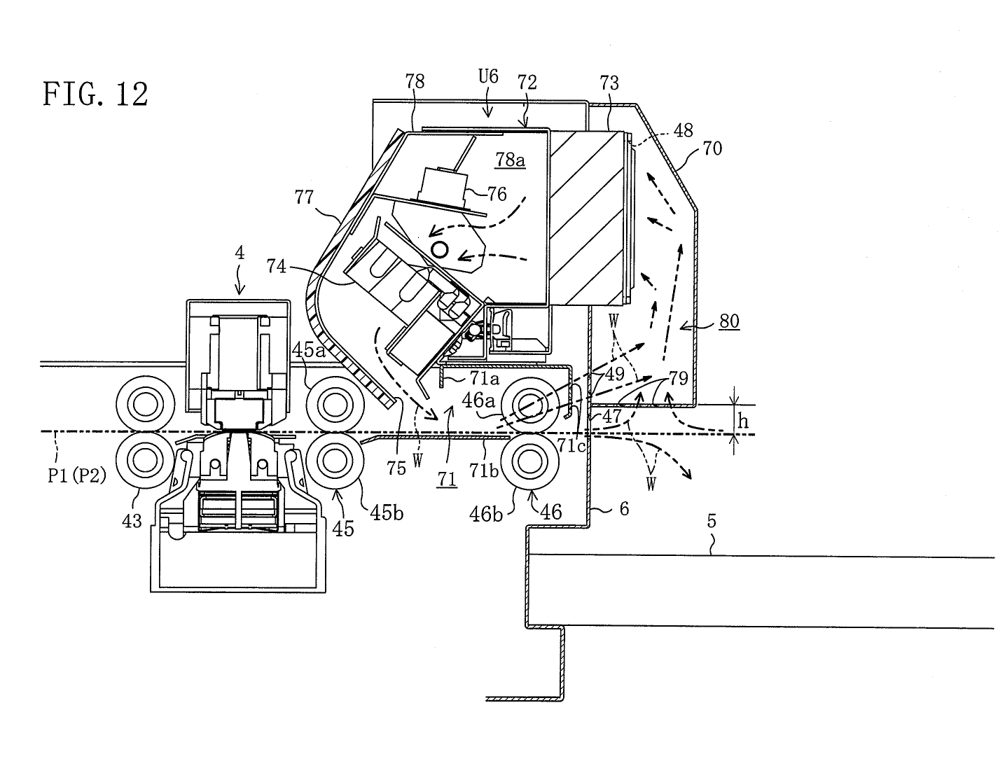

FIGS. 12-14 illustrate a third embodiment of the present invention. The third embodiment is similar to the first embodiment except that part of dry wind W blown from the dryer 72 into the drying chamber 71 is intentionally guided to the intake port 48 (which is included in a housing case acting as part of the casing 6 and used for housing the intake fans 73 in the third embodiment). Different aspects from the first embodiment will be described hereinafter.

In the third embodiment, a plurality of exhaust ports 49 for emitting part of dry wind W blown from the dryer 72 into the drying chamber 71 to outside the casing 6 are formed in the front surface of the casing 6 above the output port 47. A plurality of air vents 71c are formed in the casing front side of the upper partition wall 71a in order to guide the part of dry wind W to the exhaust ports 49.

A circulation passageway for guiding dry wind W from the exhaust ports 49 to the intake port 48 is provided between the intake port 48 and the exhaust ports 49 outside the casing 6. This circulation passageway is made of circulation space 80 defined by an external cover 70 and located inside the external cover 70. The external cover 70 covers the intake port 48 and the exhaust ports 49. The lower surface of the external cover 70 extends in parallel with a line extending from the paper conveyance path (i.e., a line extending horizontally in the drawing) in the casing 6 above the output port 47, and provides a given gap h between the lower surface of the external cover 70 and the line extending from the paper conveyance path.

The other part of dry wind W blown from the dryer 72 into the drying chamber 71 is blown to outside the casing 6 through the output port 47, in the same manner as in the first and second embodiments.

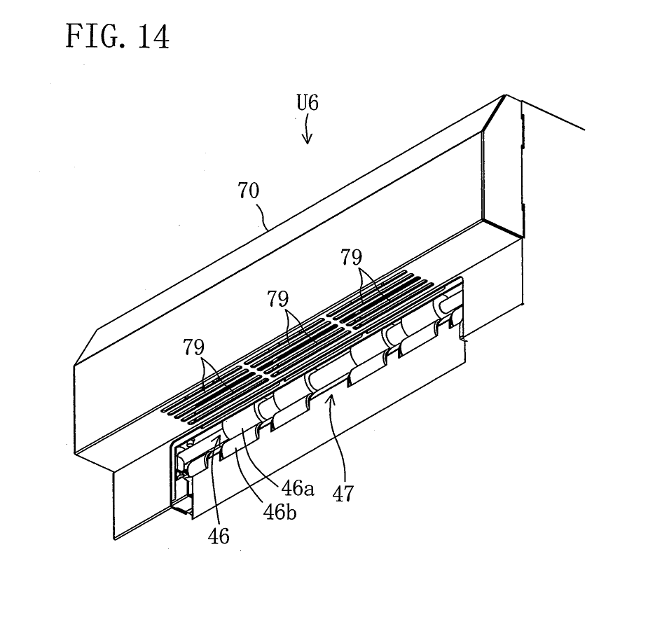

Outdoor air inlets 79 for introducing air outside the external cover 70 and the casing 6 into the circulation space 80 are formed in the lower surface of the external cover 70. As illustrated in FIGS. 13 and 14, a plurality of outside-air inlets 79 are arranged in the entire part of the lower surface of the external cover 70 in the casing front-to-rear direction in this embodiment. Alternatively, the outside-air inlets 79 may be provided only in a portion of the lower surface of the external cover 70 opposite to the output port 47.

As described above, since the outside-air inlets 79 are formed in the lower surface of the external cover 70, part of dry wind W blown to outside the casing 6 through the output port 47 (i.e., dry wind W blown upward) is introduced into the circulation space 80 through the outside-air inlets 79. In addition to the dry wind W, cold air (i.e., outside air) is introduced into the circulation space 80 through the outside-air inlets 79.

If the outside-air inlets 79 are formed in a portion of the lower surface of the external cover 70 opposite to the output port 47, the lower surface of the external cover 70 serves as the reflection member described above, and thereby, it is possible to introduce dry wind W into the circulation space 80 through the outside-air inlets 79, while allowing the dry wind W to strike the surface of the printing paper P1, P2 as much as possible.

Air introduced into the circulation space 80 in the external cover 70 through the outside-air inlets 79 and dry wind W exhausted through the exhaust ports 49 are mixed in the circulation space 80, and the air mixture is introduced into the body 78 of the dryer 72 through the intake port 48.

Here, if the gap h between the lower surface of the external cover 70 and the printing paper P1, P2 is small, dry wind W is less likely to be diffused, thereby allowing a sufficient amount of dry wind W to strike printing paper P1, P2.

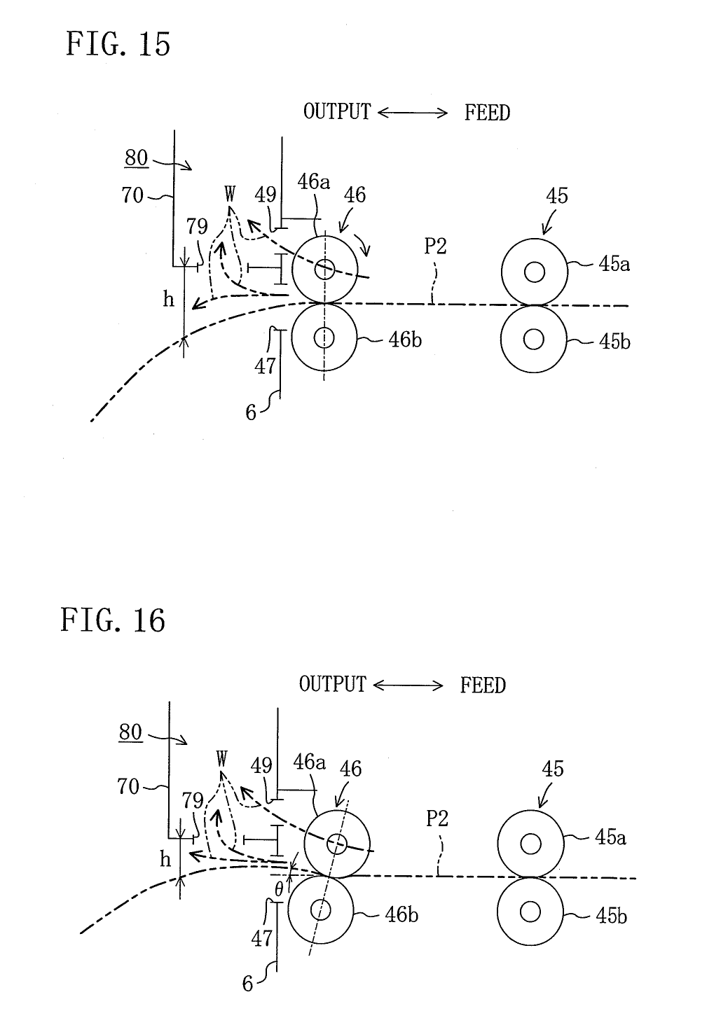

However, as illustrated in FIG. 15, the front end of printing paper P1, P2 output from the output port 47 in the horizontal direction tends to bend down. In particular, in the case of a paper roll P2 curling to round upward, the front end of printing paper P1, P2 tends to bend down to a greater extent. Accordingly, in this case, the gap between the lower surface of the external cover and the surface of the paper roll P2 increases, and thus dry wind blown through the output port 47 is likely to be diffused, resulting in that the paper roll P2 might not sufficiently dry.

To prevent this, in this embodiment, the relative positions of the upper roller 46a and the lower roller 46b of the downstream output roller 46 are changed in outputting a paper roll P2, thereby causing the downstream output roller 46 to feed the paper roll P2 obliquely upward (i.e., toward the lower surface of the external cover 70) with respect to the horizontal direction. Specifically, as illustrated in FIG. 16, when a printed paper roll P2 is conveyed to the downstream output roller 46, the upper roller 46a is moved upstream in the paper conveyance direction along the external periphery of the lower roller 46b such that the common tangent to the upper roller 46a and the lower roller 46b is inclined (at an angle of θ) upward at a downstream portion in the paper conveyance direction. In this manner, even when the paper roll P2 is curled to have its front end bend down, the gap h between the lower surface of the external cover 70 and the surface of the paper roll P2 can be reduced, thereby reducing diffusion of dry wind W. As a result, a larger amount of dry wind can strike the surface of the paper roll P2.

In this embodiment, a paper roll P2 is fed obliquely upward with respect to the horizontal direction in outputting the paper roll P2. Alternatively, irrespective of the type of printing paper P1, P2, the printing paper P1, P2 may be always fed obliquely upward with respect to the horizontal direction. Then, the relative positions of the upper roller 46a and the lower roller 46b of the downstream output roller 46 do not need to be changed according to the type of printing paper P1, P2.

As described above, in the inkjet printer A of the third embodiment, part of dry wind W blown from the dryer 72 into the drying chamber 71 is returned through the exhaust ports 49 and the circulation space 80 of the external cover 70 to the dryer 72. Accordingly, the dryer 72 requires a small amount of thermal energy for increasing the temperature of dry wind W, thereby enabling an efficient increase in the temperature of the dry wind W.

In addition, air introduced into the circulation space 80 in the external cover 70 through the outside-air inlets 79 and dry wind W emitted through the exhaust ports 49 are mixed in the circulation space 80, and the air mixture is heated by the heater 74 of the dryer 72. Accordingly, the dryer 72 can produce dry wind W exhibiting no uneven temperature distribution. Specifically, it is possible to pass only dry wind W from the exhaust ports 49 to the dryer 72 without providing outside-air inlets 79 in the external cover 70. In this case, however, uneven temperature distribution occurs, i.e., the temperature of the body 78 of the dryer 72 locally increases. When dry wind W is blown into the drying chamber 71 in this state, printing paper P1, P2 does not dry uniformly, resulting in that nonuniformity in drying might occur. However, since dry wind W emitted through the exhaust ports 49 is mixed with air introduced through the outside-air inlets 79 in this embodiment as described above, air is more efficiently diffused in the body 78 of the dryer 72, and thus uneven temperature distribution is less likely to occur in the body 78. Consequently, dry wind W exhibiting a desired drying ability can be easily produced with stability. For the foregoing reason, dry wind W is preferably mixed with air introduced through the outside-air inlets 79.

Air to be introduced into the circulation space 80 through the outside-air inlets 79 preferably includes dry wind W blown through the output port 47. Specifically, since the temperature of dry wind W blown through the output port 47 is lower than dry wind W emitted through the exhaust ports 49, mixture of the dry wind W blown through the output port 47 with the dry wind W emitted through the exhaust ports 49 can reduce a variation in temperature distribution in the body 78 of the dryer 72. On the other hand, since the temperature of the dry wind W blown through the output port 47 is higher than outside air, dry wind W exhibiting a desired drying ability can be more efficiently produced.

However, dry wind W blown through the output port 47 is not necessarily introduced into the circulation space 80, and the outside-air inlets 79 may be formed at positions (e.g., in the upper portion of the external cover 70) to allow only cold air outside the external cover 70 and the casing 6 to be introduced into the circulation space 80.

### INDUSTRIAL APPLICABILITY

The present disclosure is useful for an inkjet printer for printing an image on paper by ejecting ink from a print head onto the paper in the course of conveyance of the paper, and particularly for an inkjet printer for a large amount of printing in, for example, a photographic printing system.

1. An inkjet printer configured to print an image on paper by ejecting ink from a print head onto the paper while conveying the paper, the inkjet printer comprising:
a casing incorporating the print head and having an output port through which the printed paper is output to outside the casing;
a drying chamber provided on a conveyance path downstream of the print head in a paper conveyance direction in the casing, and communicating with the output port; and
a dryer configured to blow dry wind for drying ink on the printed paper into the drying chamber, wherein
the dryer is configured to blow the dry wind downstream in the paper conveyance direction in the drying chamber, and
the dry wind from the dryer is blown to outside the casing through the output port of the casing.

2. The inkjet printer of claim 1, wherein an output roller configured to output the printed paper to outside the casing is provided near the output port in the casing, and
the output roller includes an air passageway configured to allow dry wind blown downstream in the paper conveyance direction from the dryer to be supplied toward the output port.

3. The inkjet printer of claim 2, wherein the output roller includes a roller shaft extending in a width direction of the paper and a plurality of roller parts spaced from each other along an axis of the roller shaft, and
the air passageway is provided between each two of the roller parts.

4. The inkjet printer of claim 1, wherein a heat insulating material is provided in an upstream portion of an outer wall of a body of the dryer in the paper conveyance direction.

5. The inkjet printer of claim 1, wherein the casing includes an intake port configured to take air in the casing,
the dryer includes an intake unit configured to take air through the intake port and a heating unit configured to heat air taken by the intake unit, and is configured to blow air heated by the heating unit into the drying chamber as the dry wind, and
the intake port of the casing is located near the output port.

6. The inkjet printer of claim 1, further comprising a mount part configured to receive, and place thereon, paper output through the output port of the casing, and
dry wind blown to outside the casing strikes paper placed on the mount part.

7. The inkjet printer of claim 6, wherein the mount part is part of a conveyance belt configured to convey the paper, and
an accumulation device configured to receive, and accumulate therein, paper conveyed by the conveyance belt is provided downstream of the conveyance belt in the paper conveyance direction.

8. The inkjet printer of claim 7, wherein the conveyance belt is driven such that paper placed on the mount part is withdrawn from the mount part before next paper output through the output port of the casing is placed on the mount part.

9. The inkjet printer of claim 7, wherein the conveyance belt is driven such that paper conveyed by the conveyance belt is fed to the accumulation device at a feed speed equal to or higher than a given speed.

10. The inkjet printer of claim 1, wherein the casing includes an intake port through which air is taken in the casing,
the dryer includes an intake unit configured to take air through the intake port and a heating unit configured to heat air taken by the intake unit, and is configured to blow air heated by the heating unit into the drying chamber as the dry wind,
the casing further includes an exhaust port through which part of dry wind blown into the drying chamber from the dryer is emitted to outside the casing, in addition to the output port,
a circulation passageway configured to guide dry wind from the exhaust port to the intake port is provided between the intake port and the exhaust port outside the casing, and
part of the dry wind blown from the dryer into the drying chamber is guided to the intake port through the exhaust port and the circulation passageway, whereas the other part of the dry wind is blown to outside the casing through the output port.

11. The inkjet printer of claim 10, wherein the circulation passageway is made of circulation space formed by an external cover and located inside the external cover,
the external cover covers the intake port and the exhaust port,
the external cover includes an outside-air inlet through which air is introduced from outside the external cover and the casing into the circulation space,
air introduced into the circulation space of the external cover through the outside-air inlet and dry wind emitted through the exhaust port are mixed in the circulation space to form an air mixture, and
the air mixture is taken in the casing through the intake port.

12. The inkjet printer of claim 11, wherein the external cover is located above the output port of the casing, and
part of dry wind blown to outside the casing through the output port is introduced into the circulation space through the outside-air inlet.

13. The inkjet printer of claim 12, wherein the outside-air inlet of the external cover is located at a portion of a lower surface of the external cover opposite to the output port of the casing.

14. The inkjet printer of claim 12, wherein output rollers including an upper roller and a lower roller facing the upper roller are provided near the output port in the casing, and are pressed against each other, and
the output rollers are configured to feed the paper obliquely upward with respect to a horizontal direction.
